(19) United States
(12) Patent Application Publication
(10) Pub. No.: US 2026/0177695 A1
(43) Pub. Date: Jun. 25, 2026

(54) MOUNTING MEMBER

(71) Applicant: DENSO CORPORATION, Kariya-city (JP)

(72) Inventors: Kota TOYAMA, Kariya-city (JP); Taketo HARADA, Kariya-city (JP)

(21) Appl. No.: 19/539,843

(22) Filed: Feb. 13, 2026

Related U.S. Application Data
(63) Continuation of application No. PCT/JP2024/033786, filed on Sep. 23, 2024.

(30) Foreign Application Priority Data
Sep. 29, 2023 (JP) 2023-170451

(51) Int. Cl. G01S 15/931; B60R 11/00; B60R 11/04; B60R 19/00; B60R 19/18; B60R 19/24; B60R 19/48

(52) U.S. Cl. CPC G01S 15/931; B60R 11/00; B60R 11/04; B60R 19/00; B60R 19/18; B60R 19/24; B60R 19/48; B60R 19/483; B60R 2011/005

(57) ABSTRACT

A mounting member for attaching a component to a vehicle has displayed thereon an identification symbol indicating a required mounting orientation by shape.

### CROSS REFERENCE TO RELATED DOCUMENT

The present application claims the benefit of priority of Japanese Patent Application No. 2023-170451 filed on Sep. 29, 2023, the disclosure of which is incorporated in its entirety herein by reference.

### TECHNICAL FIELD

This disclosure generally relates to a mounting member used to attach a component onto a vehicle.

### BACKGROUND ART

An ultrasonic sensor that detects an object around a vehicle is mounted on the vehicle by, for example, the method described in Patent Document 1. Specifically, a mounting hole is formed in a vehicle body. A mounting member is inserted into the mounting hole. The ultrasonic sensor is fixed to the mounting member, thereby attaching the ultrasonic sensor on the vehicle.

### PRIOR ART DOCUMENT

### [Patent Document]

Patent Document 1: Japanese Unexamined Patent Application Publication No. 2020-82986

### SUMMARY OF THE INVENTION

Usually, an irradiation direction and an irradiation range of ultrasonic waves vary depending on an orientation of an ultrasonic sensor. The mounting of the ultrasonic sensor on a vehicle using the above-described method, therefore, causes the irradiation direction of the ultrasonic waves to change depending on an orientation of the mounting member. Therefore, in order to obtain a desired irradiation direction, it is necessary to insert the mounting member in an appropriate orientation. For example, a method may be considered in which characters for identifying a mounting orientation are displayed on the mounting member so that an appropriate mounting orientation can be recognized. However, with this method, a mounting operator needs to recognize in advance a correspondence between the characters and the mounting orientation, which may reduce workability.

In view of the above points, it is an object for the present disclosure to provide a mounting member that is capable of minimizing a reduction in workability.

In order to achieve the above object, according to one aspect of the present disclosure, there is provided a mounting member for attaching a component to a vehicle, wherein an identification symbol indicating a required mounting orientation by shape is displayed.

The indication of the mounting orientation using a shape of an identification symbol in the above manner, therefore, facilitates the ease with which an operator intuitively recognizes the mounting orientation as compared with a case in which the mounting orientation is indicated by characters, thereby making it possible to suppress a reduction in workability.

Reference numerals in parentheses attached to respective constituent elements and the like indicate examples of a correspondence relationship between the constituent elements and the like and specific constituent elements and the like described in embodiments to be described later.

### BRIEF DESCRIPTION OF THE DRAWINGS

FIG. 1A is a front view of a mounting member according to the first embodiment.

FIG. 1B is a top view of a mounting member according to the first embodiment.

FIG. 1C is a bottom view of a mounting member according to the first embodiment.

FIG. 1D is a side view of a mounting member according to the first embodiment.

FIG. 2 is a perspective view showing a state in which an ultrasonic sensor is mounted.

FIG. 3 is a diagram showing an arrangement of ultrasonic sensors.

FIG. 4A is a front view of a first mounting hole.

FIG. 4B is a front view of a second mounting hole.

FIG. 4C is a front view of third and fourth mounting holes.

FIG. 5A is an enlarged view of a first surface of a first mounting member.

FIG. 5B is an enlarged view of a first surface of a second mounting member.

FIG. 5C is an enlarged view of a first surface of each of third and fourth mounting members.

FIG. 6A is an enlarged view of a second surface of a first mounting member.

FIG. 6B is an enlarged view of a second surface of a second mounting member.

FIG. 6C is an enlarged view of a second surface of each of third and fourth mounting members.

FIG. 7A is a perspective view showing a state in which a first mounting member is fit in a first mounting hole.

FIG. 7B is a perspective view showing a state in which a second mounting member is fit in a second mounting hole.

FIG. 7C is a perspective view showing a state in which a third mounting member is fit in a third mounting hole.

FIG. 7D is a perspective view showing a state in which a fourth mounting member is fit in a fourth mounting hole.

FIG. 8A is a top view of a comparative example.

FIG. 8B is a top view of a comparative example.

FIG. 9A is an enlarged view of a first surface of a first mounting member according to the second embodiment.

FIG. 9B is an enlarged view of a second surface of a first mounting member according to the second embodiment.

FIG. 10A is an enlarged view of a first surface of a first mounting member according to the third embodiment.

FIG. 10B is an enlarged view of a second surface of a first mounting member according to the third embodiment.

FIG. 11 is an enlarged view of a second surface of a first mounting member according to the third embodiment.

FIG. 12 is a perspective view showing a state in which an ultrasonic sensor is mounted according to the fourth embodiment.

### MODE FOR CARRYING OUT THE INVENTION

Embodiments in this disclosure will be described below with reference to the drawings. In the following embodiments, parts that are identical or equivalent to each other are denoted by the same reference symbols or numerals and will be described accordingly.

### First Embodiment

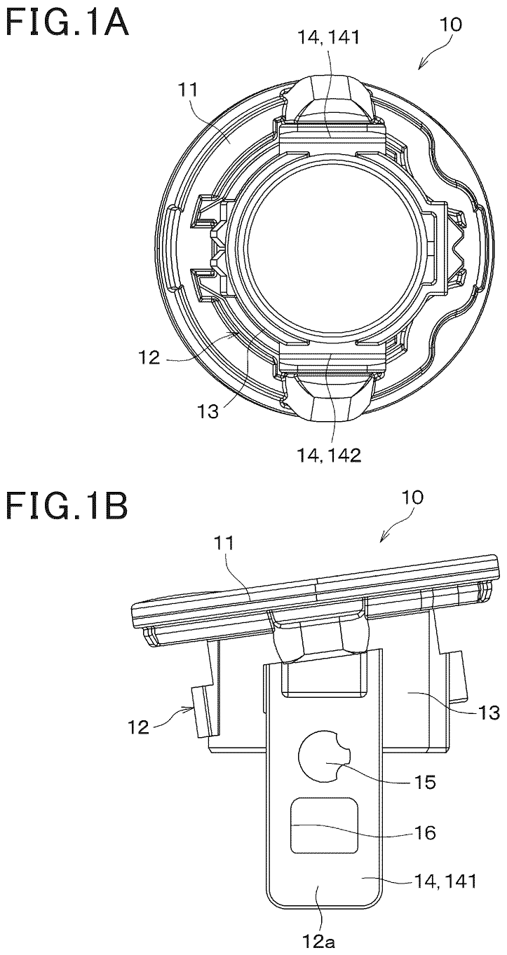

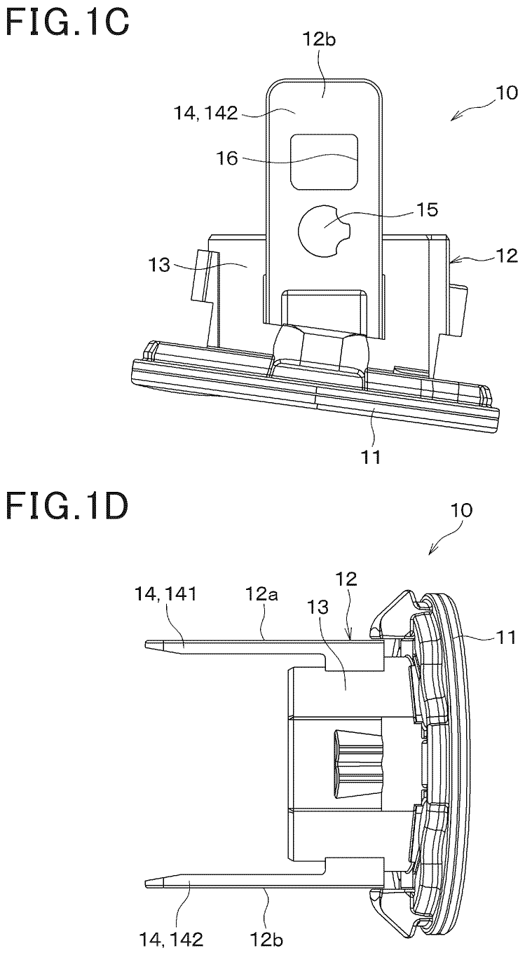

The first embodiment will be described. The mounting member 10 shown in FIG. 1A to FIG. 1D is used for attaching a component or part to a vehicle. In the present embodiment, a case where the ultrasonic sensor 20 shown in FIG. 2 is attached to the vehicle as the part will be described; however, the mounting member 10 may also be used for attaching another part.

As shown in FIG. 1A to FIG. 1D, the mounting member 10 includes the annular portion 11 and the upright portion 12. The annular portion 11 is a disk-shaped member in which a circular through-hole is formed at a center thereof. The upright portion 12 includes the hollow cylindrical tubular portion 13 erected from the annular portion 11, and the plate portions 14 disposed on a side surface of the tubular portion 13. An internal space of the tubular portion 13 communicates with the through-hole at the center of the annular portion 11. The ultrasonic sensor 20 is fixed such that the tubular portion 23, which will be described later, is inserted into the tubular portion 13 and the distal end surface of the tubular portion 23 is exposed from the through-hole of the annular portion 11.

The plate portions 14 are disposed at two locations on a side surface of the tubular portion 13. The plate portions 14 disposed at the two locations will be referred to below as the plate portion 141 and the plate portion 142, respectively. The plate portion 141 and the plate portion 142 are each formed in a substantially rectangular plate shape and extend in an erecting direction (i.e., a length-wise direction or axial direction) of the tubular portion 13. The plate portion 141 and the plate portion 142 are disposed on opposite sides of the tubular portion 13 in a direction perpendicular to the axial direction of the tubular portion 13. Specifically, as can be seen in FIG. 1D, the plate portion 141 is disposed on an upper portion of the side surface of the tubular portion 13, while the plate portion 142 is disposed on a lower portion of the side surface of the tubular portion 13.

The mounting member 10 is provided with the identification symbols 15 each of which indicates a required or target mounting orientation of the mounting member 10 in the form of a visual shape. Each of the identification symbols 15 is composed of a symbol different from characters. In the present embodiment, each of the identification symbols 15 is a symbol having a shape conforming with a shape of a mounting hole in the vehicle. The identification symbols 15 are displayed on the first surface 12a of the upright portion 12 and on the second surface 12b diametrically opposite to the first surface 12a.

In the present embodiment, outer surfaces of the plate portions 141 and 142, which face away from the tubular portion 13, are defined as the first surface 12a and the second surface 12b, respectively, and the identification symbols 15 are displayed on the first surface 12a and the second surface 12b by, for example, cutting or printing.

The upright portion 12 has formed therein the openings 16 used to achieve physical engagement with the ultrasonic sensor 20. Each of the identification symbols 15 is arranged between the annular portion 11 and the opening portion 16.

The ultrasonic sensor 20 works to detect an object around the vehicle. As shown in FIG. 2, the ultrasonic sensor 20 includes the housing 21 and the connecting portion 22. The housing 21 is a box-shaped member which defines an inner space. The housing 21 has the hollow cylinder 23 which is formed on a front surface thereof and protrudes outside the housing 21.

The housing 21 has disposed therein a signal processor composed of a DSP (Digital Signal Processor). The cylinder 23 has mounted therein a microphone that transmits and receives ultrasonic waves. The microphone outputs the received ultrasonic wave in the form of a received signal which is filtered in the signal processor and then transmitted to an ECU (Electronic Control Unit) using wiring disposed inside the connecting portion 22.

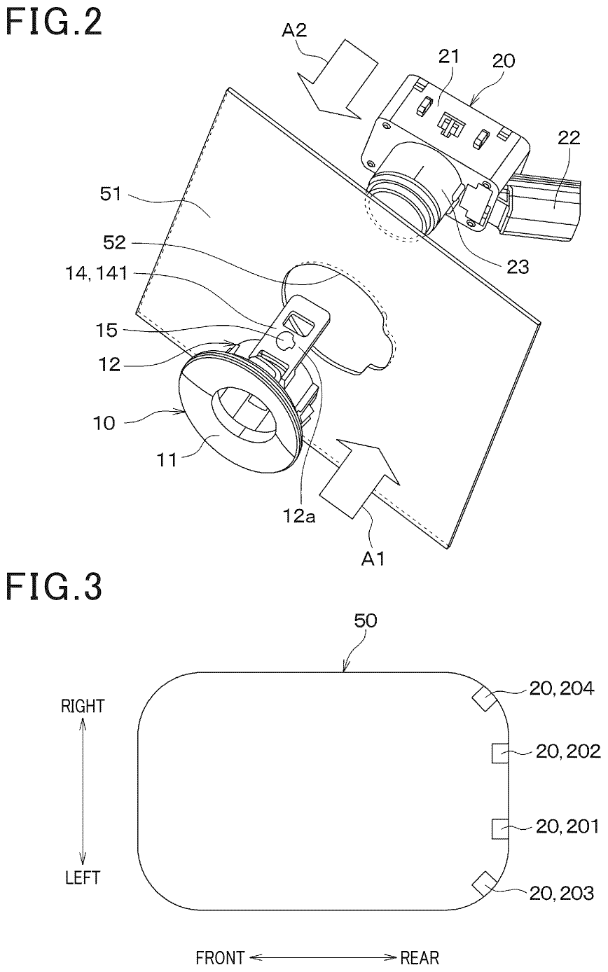

As shown in FIGS. 2 and 3, the ultrasonic sensor 20 is mounted on the vehicle 50. Specifically, the bumper 51 of the vehicle 50 has formed therein the mounting hole 52 for use in attaching the mounting member 10 to the bumper 51. The bumper 51 is a plate-shaped member made of metal or resin. The mounting hole 52 penetrates the bumper 51 in a thickness direction of the bumper 51. As indicated by the arrow A1 in FIG. 2, the mounting member 10 is inserted into the mounting hole 52. The tubular portion 23 of the ultrasonic sensor 20 is, as indicated by the arrow A2, inserted into the tubular portion 13, whereby the ultrasonic sensor 20 is fixed to the vehicle 50 through the mounting member 10.

The bumper 51 is disposed on the rear of the vehicle 50. The bumper 51 extends from a left rear corner to a right rear corner of the vehicle 50. In this embodiment, four mounting holes 52 are formed in the bumper 51, and four ultrasonic sensors 20 are installed in the mounting holes 52, respectively.

Two of the four mounting holes 52 are formed in a central portion of a rear surface of the vehicle 50 and arranged at an interval away from each other in the lateral direction of the vehicle 50, while the remaining two mounting holes 52 are formed in the left rear corner and the right rear corner of the vehicle 50. The four mounting members 10 and the four ultrasonic sensors 20 are fixed to the mounting holes 52 formed in this manner. The layout of the four ultrasonic sensors 20 is demonstrated in FIG. 3.

In the following discussion, the mounting holes 52 formed in the left side of the center of the rear surface of the vehicle 50, the right side of the center of the rear surface, the left rear corner, and the right rear corner will be respectively referred to as first to fourth mounting holes 521 to 524. In addition, the mounting members 10 inserted into the first to fourth mounting holes 521 to 524 will respectively referred to as the first to fourth mounting members 101 to 104. The ultrasonic sensors 20 fixed to the first to fourth mounting holes 521 to 524 using the first to fourth mounting members 101 to 104 will also be respectively referred to as first to fourth ultrasonic sensors 201 to 204.

Usually, the detection region of the ultrasonic sensor 20 varies depending on the orientation thereof. In order to obtain a desired detection region of the ultrasonic sensor 20, it is, therefore, necessary to insert the first to fourth mounting members 101 to 104 into the first to fourth mounting holes 521 to 524 in appropriate orientations. Note that the annular portion 11 of each of the first to fourth mounting members 101 to 104 has a portion raised in a shape corresponding to the respective first to fourth mounting holes 521 to 524. By inserting the mounting member 10 to have the raised portion fitted into the mounting hole 52, the orientation of the upright portion 12 is fixed, thereby allowing the ultrasonic sensor 20 to be mounted at a desired angle.

In the present embodiment, a case will be described in which each of the mounting members 10 are inserted into a corresponding one of the mounting holes 52 such that the plate portion 141 or the plate portion 142 is positioned on the upper side. Specifically, each of the first and second mounting members 101 and 102 in this embodiment is designed such that the plate portion 141 is positioned on the upper side, whereas each of the third and fourth mounting members 103 and 104 in this embodiment is designed such that either the plate portion 141 or the plate portion 142 may be positioned on the upper side. Further, it is assumed that an operator who attaches each of the mounting members 10 to a corresponding one of the mounting holes 52 performs the attachment while viewing the mounting member 10 and the mounting hole 52 from above an outer side of the bumper 51.

The shapes of the first and second mounting holes 521 and 522, as viewed by an operator, in other words, the shapes of the first and second mounting holes 521 and 522, as viewed from an upper rear outer side of the vehicle 50, are contoured to correspond to the mounting directions of the first and second mounting members 101 and 102 described above.

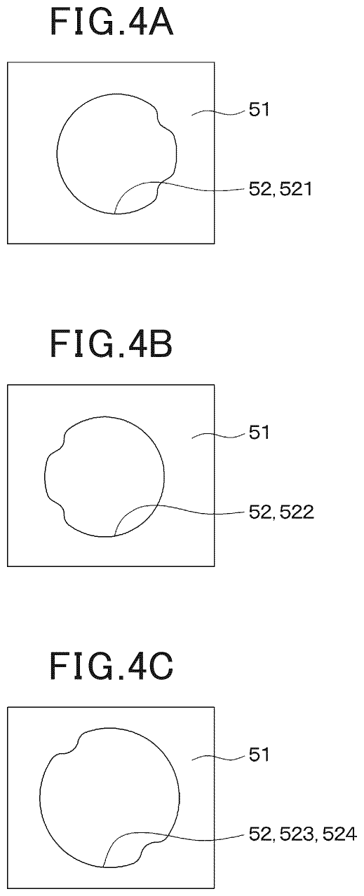

Specifically, the first mounting hole 521, as clearly illustrated in FIG. 4A, has a convex shape in which a protrusion or convex portion faces in the right direction of the vehicle 50. The second mounting hole 522, as illustrated in FIG. 4B, has a convex shape in which a protrusion or convex portion faces in the left direction of the vehicle 50. In other words, each of the first and second mounting holes 521 and 522 is shaped to be rotationally asymmetric with respect to the center thereof.

The shapes of the third and fourth mounting holes 523 and 524, as viewed by the operator, in other words, the shapes of the third and fourth mounting holes 523 and 524, as viewed from the upper rear outer side of the vehicle 50, are contoured to correspond to the mounting directions of the third and fourth mounting members 103 and 104 described above. Specifically, as shown in FIG. 4C, each of the third and fourth mounting holes 523 and 524 has a substantially circular shape in which concave portions or recesses are formed at an upper left portion and a lower right portion thereof. The recesses at the upper left portion and the lower right portion are formed such that each of the third and fourth mounting holes 523 and 524 has a rotationally symmetric shape with respect to the center thereof.

In correspondence with the shapes of the first to fourth mounting holes 521 to 524 described above, the identification symbols 15 displayed on the first surface 12a of each of the first to fourth mounting members 101 to 104 have shapes as described below.

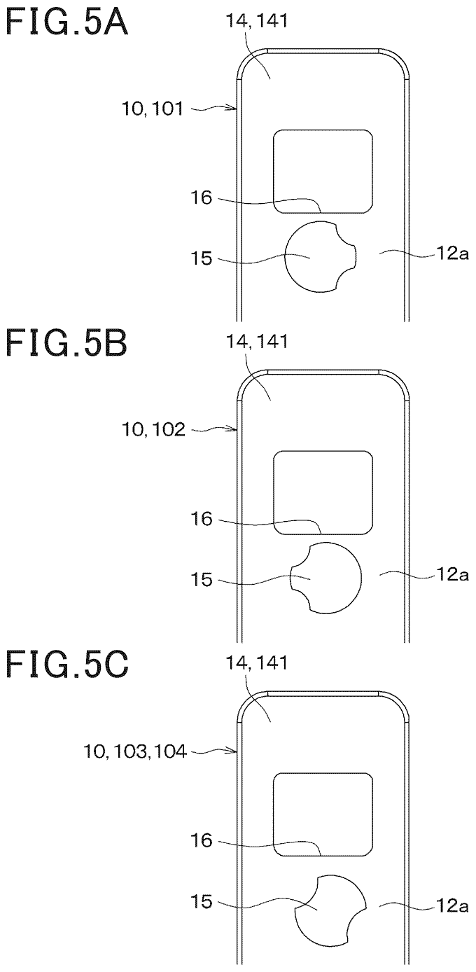

Specifically, the identification symbol 15 of the first mounting member 101, as illustrated in FIG. 5A, has a convex shape in which a protrusion or convex portion faces in the right direction of the vehicle 50 when the first mounting member 101 is in an orientation in which the first surface 12a faces upward and is inserted into the mounting hole 52. The identification symbol 15 of the second mounting member 102, as illustrated in FIG. 15B, has a convex shape in which a protrusion or convex portion faces in the left direction of the vehicle 50 when the second mounting member 102 is in the same orientation as described above.

Further, the identification symbol 15 of each of the third and fourth mounting members 103 and 104, as illustrated in FIG. 5C, has a substantially circular shape with two concave portions or recesses, and, when each of the third and fourth mounting members 103 and 104 is in the same orientation as described above, the two recesses face in the left-front direction and the right-rear direction of the vehicle 50.

Note that, the second surface 12b, which is opposite to, that is, faces away from the first surface 12a of each of the third and fourth mounting members 103 and 104, has displayed thereon the identification symbol 15 (which will also be referred to below as a second identification symbol) having a shape symmetric to the identification symbol 15 (which will also be referred to below as a first identification symbol) on the first surface 12a.

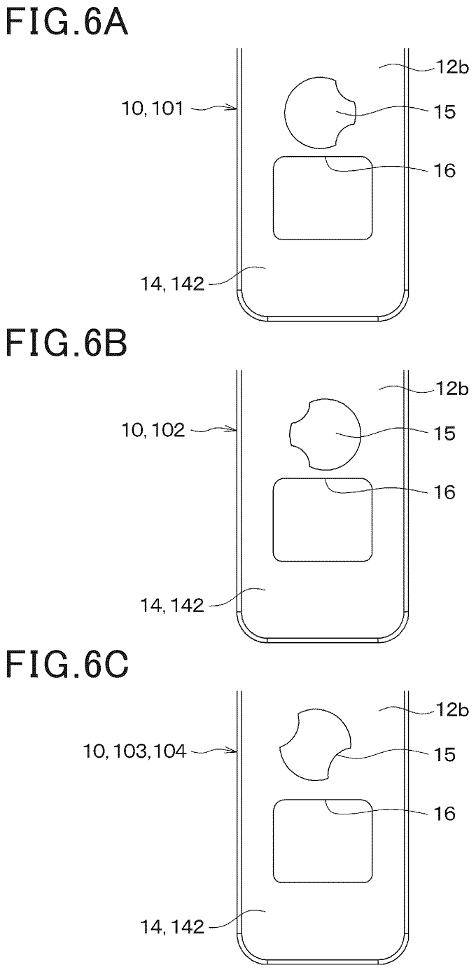

Specifically, the second surface 12b of each of the first and second mounting members 101 and 102, as illustrated in FIG. 6A or 6B, has displayed thereon the convex identification symbol 15 in which the convex portion faces in the same direction as the identification symbol 15 on the first surface 12a.

The second surface 12b of each of the third and fourth mounting members 103 and 104, as illustrated in FIG. 6C, has a substantially circular shape with two recesses and, when each of the third and fourth mounting members 103 and 104 is in the same orientation as described above, the two recesses are disposed to face in the right-front direction and the left-rear direction of the vehicle 50. In other words, the identification symbols 15 on the second surfaces 12b of the third and fourth mounting members 103 and 104 are configured such that, when each of the third and fourth mounting members 103 and 104 is in an orientation in which the second surface 12b faces upward and is inserted into the mounting hole 52, the two recesses are disposed to face in the left-front direction and the right-rear direction of the vehicle 50.

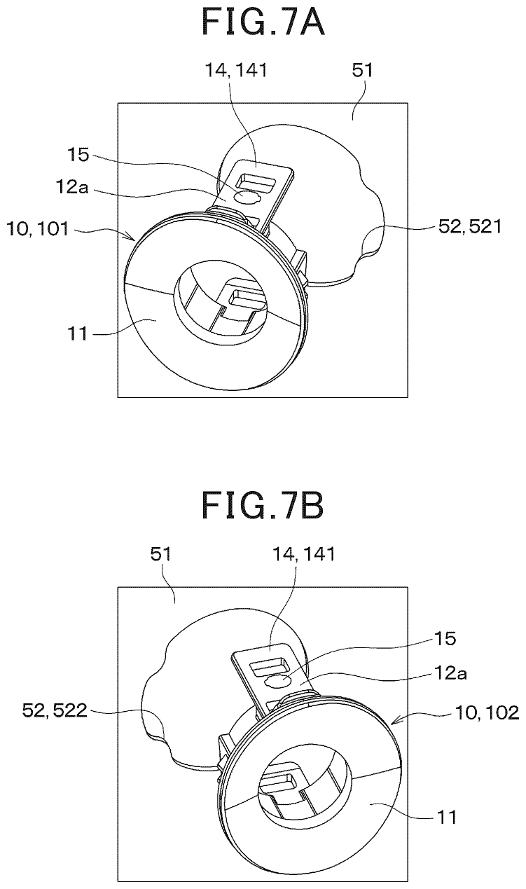

The operator watches the identification symbols 15 displayed as described above, determines the mounting directions of the mounting members 10, and mounts the mounting members 10 to the bumper 51. Specifically, when attaching the first mounting member 101 to the first mounting hole 521, the operator inserts the first mounting member 101 into the first mounting hole 521 as shown in FIG. 7A.

When the first mounting member 101 is inserted into the first mounting hole 521 in a correct orientation, that is, in an orientation in which the first surface 12a faces upward, it enables the operator to view the identification symbol 15 having a shape similar to that of the first mounting hole 521. Accordingly, the operator can intuitively recognize that the orientation of the first mounting member 101 is correct.

Alternatively, when the first mounting member 101 is in a reverse orientation, that is, in an orientation in which the second surface 12b faces upward, it causes the operator to view the identification symbol 15 having a shape opposite to that of the first mounting hole 521. Accordingly, the operator can intuitively recognize that the orientation of the first mounting member 101 is incorrect, and can correct the orientation of the first mounting member 101.

When attaching the second mounting member 102 to the second mounting hole 522, the operator inserts the second mounting member 102 into the second mounting hole 522 in the manner demonstrated in FIG. 7B.

When the second mounting member 102 is inserted into the second mounting hole 522 in a correct orientation, that is, in an orientation in which the one surface 12a faces upward, it enables the operator to view the identification symbols 15 having a shape similar to that of the second mounting hole 522. Accordingly, the operator can intuitively recognize that the orientation of the second mounting member 102 is correct.

Alternatively, when the second mounting member 102 is in a reverse orientation, that is, in an orientation in which the second surface 12b faces upward, it causes the operator to view the identification symbol 15 having a shape opposite to that of the second mounting hole 522. Accordingly, the operator can intuitively recognize that the orientation of the second mounting member 102 is incorrect, and can correct the orientation of the second mounting member 102.

When attaching the third mounting member 103 to the third mounting hole 523, the operator inserts the third mounting member 103 into the third mounting hole 523 in the manner demonstrated in FIG. 7C. At this time, if the third mounting member 103 is in a correct orientation, that is, in an orientation in which the one surface 12a faces upward, it enables the operator to view the identification symbols 15 having a shape similar to that of the third mounting hole 523. Accordingly, the operator can intuitively recognize that the orientation of the third mounting member 103 is correct.

When attaching the fourth mounting member 104 to the fourth mounting hole 524, the operator inserts the fourth mounting member 104 into the fourth mounting hole 524 in the manner demonstrated in FIG. 7D. At this time, if the fourth mounting member 104 is in a correct orientation, that is, in an orientation in which the one surface 12a faces upward, it enables the operator to view the identification symbols 15 having a shape similar to that of the fourth mounting hole 524. Accordingly, the operator can intuitively recognize that the orientation of the fourth mounting member 104 is correct.

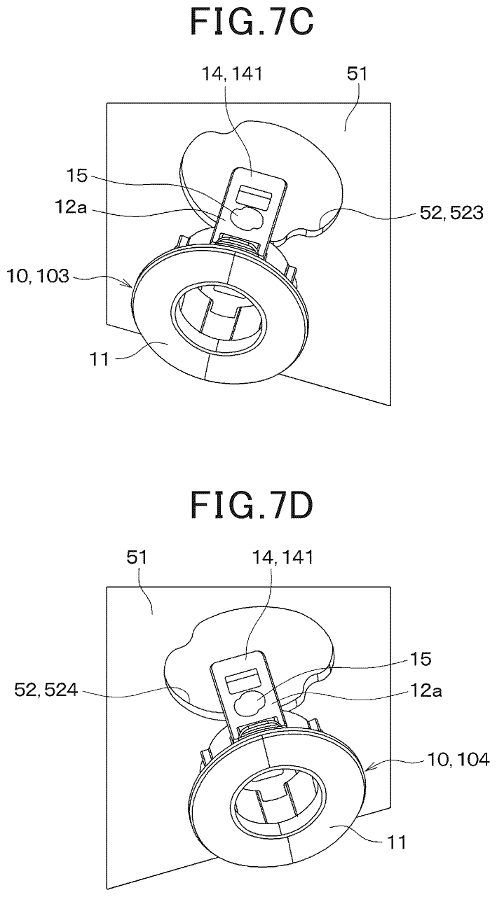

FIGS. 8A and 8B demonstrate comparative examples in which the letter “L” is displayed on the first surface 12a of the first mounting member 101, and the letter “R” is displayed on the first surface 12a of the second mounting member 102. Before attaching the first mounting member 101 and the second mounting member 102 to the mounting holes 521 and 522, the operator recognizes in advance that the letters “L” and “R” respectively correspond to the first mounting hole 521 and the second mounting hole 522.

Then, upon seeing the letter “L”, the operator determines that a target in which the first mounting member 101 should be fit is the first mounting hole 521, and inserts the first mounting member 101 into the first mounting hole 521 with the letter “L” oriented upward. Further, upon seeing the letter “R”, the operator determines that a target in which the second mounting member 102 should be fit is the second mounting hole 522, and inserts the second mounting member 102 into the second mounting hole 522 with the letter “R” oriented upward.

The above-described method in which letters for identifying required mounting orientations are displayed on the mounting member 10 so as to enable an appropriate mounting orientation to be recognized requires the operator to recognize in advance a correspondence between the letters and the mounting orientation, which may cause a reduction in workability.

In contrast, the structure in the present embodiment has the identification symbols 15 indicating the mounting orientations by shape are displayed on the mounting members 10. Accordingly, as compared with a case in which the mounting orientation of each of the mounting members 10 is indicated by a letter, the operator can more intuitively recognize the mounting orientation of each of the mounting member 10, and thus a reduction in workability can be suppressed.

Further, a case is assumed in which the mounting members 10 are mounted on a plurality of vehicle models and the mounting positions of the mounting members 10 vary depending on the vehicle model. In this case, when the mounting orientation of each of the mounting members 10 is indicated by a letter, the operator needs to memorize a correspondence between the letters and the mounting position for each vehicle model, which may cause a reduction in workability.

In contrast, in the present embodiment, since the mounting orientation of each of the mounting members 10 can be intuitively recognized, even in the above-described case, a reduction in workability can be suppressed.

Further, for example, a method of indicating the mounting orientation of each of the mounting members 10 on an inner wall of the bumper 51 by scribing or the like may be considered. However, when the bumper 51 is made of metal, scribing is difficult.

In contrast, the structure in the present embodiment eliminates the need for indicating the mounting orientations on the bumper 51, thereby facilitating attaching the mounting members 10 even to portions of the bumper 51 that are formed of metal and have inner flat surfaces without scribing. Note that the inner surface of the bumper 51 have planar or curved portions. FIG. 2 illustrates a state in which the mounting member 10 is attached to a portion of the bumper 51 whose rear or inner surface is flat. However, the mounting member 10 may be mounted on a portion of the bumper 51 whose inner surface is a smooth curved surface without scribing or a substantially flat surface.

The structure in this embodiment provides the following beneficial effects.

1) The first surface 12a and the second surface 12b of each of the mounting members 10 have disposed thereon the identification symbols 15 having shapes symmetrical to each other. Accordingly, when the first surface 12a is selected in advance to be oriented upward, if the second surface 12b is oriented upward, the operator can easily recognize that the mounting member 10 is oriented in a direction opposite to a correct mounting orientation. Further, when either the first surface 12a or the second surface 12b may be oriented upward, regardless of whether the first surface 12a or the second surface 12b is oriented upward, the operator can easily recognize that the mounting member 10 is in the correct mounting orientation.

2) The identification symbols 15 are, as described above, designed to have shapes corresponding to shapes of the mounting holes 52. Such geometry of each identification symbol 15 facilitates the ease with which the operator visually perceives the mounting orientations of the mounting members 10. For example, when the same letters are displayed on a plurality of the mounting members 10 having similar shapes and mounted on different vehicle models, it becomes difficult to distinguish among the plurality of the mounting members 10. As a result, when the mounting members 10 are used in common for a plurality of vehicle models or mounting locations, workability may be reduced. In contrast, by forming the identification symbols 15 into shapes corresponding to the shapes of the mounting holes 52, it becomes easier to distinguish among the plurality of the mounting members 10 having similar shapes. Therefore, when the mounting members 10 are used in common for a plurality of vehicle models or mounting locations, a reduction in workability can be suppressed.

3) The identification symbol 15 is arranged to appear between the opening 16 and the annular portion 11 of each mounting member 10. This layout of the identification symbols 15, as compared with a case in which the identification symbols 15 are displayed at another position, facilitates making the identification symbols 15 have an increased size, thereby facilitating confirmation of the identification symbols 15 and intuitive recognition of the mounting orientations. Further, by showing each identification symbol 15 at the above-described position, the identification symbols 15 are concealed by the bumper 51 after the mounting members 10 are mounted, thereby improving design quality of the vehicle 50.

### Second Embodiment

The second embodiment will be described below which differs from the first embodiment in the shape of each identification symbol 15. Other configurations are the same as those of the first embodiment. Therefore, only differences from the first embodiment will be described.

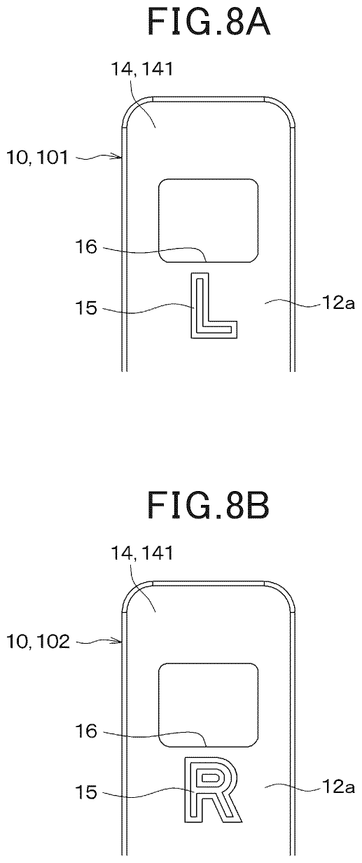

Each of the mounting members 101 in the second embodiment, as illustrated in FIG. 9A, has the arrow-shaped identification symbol 15 appearing on the first surface 12a. The arrow indicates the center of the vehicle 50 defined in the lateral direction of the vehicle 50. The correct mounting orientation of the first mounting member 101, which is designed to be arranged on the left side of the vehicle 50, is established by directing the first mounting member 101 to have the arrow oriented toward the right side of the operator. The second mounting member 102 is designed to be arranged on the right side of the vehicle 50 and has an arrow that is displayed on the first surface 12a and faces in a direction opposite to that shown in FIG. 9A. The correct mounting orientation of the second mounting member 102 is achieved by directing the second mounting member 102 to have the arrow oriented toward the left side of the operator.

Each of the mounting members 101, as illustrated in FIG. 9B, also has the arrow-shaped identification symbol 15 appearing on the second surface 12b. The arrow indicates the center of the vehicle 50 defined in the lateral direction of the vehicle 50. The correct mounting orientation of the first mounting member 101, which is designed to be arranged on the left side of the vehicle 50, is established by directing the first mounting member 101 to have the arrow oriented toward the right side of the operator. The second mounting member 102 is designed to be arranged on the right side of the vehicle 50 and has an arrow that is displayed on the first surface 12a and faces in a direction opposite to that shown in FIG. 9A. The correct mounting orientation of the second mounting member 102 is achieved by directing the second mounting member 102 to have the arrow oriented toward the left side of the operator. When the first mounting member 101, which is designed to be arranged on the left side of the vehicle 50, is oriented with the second surface 12b facing upward, it causes the arrow on the second surface 12b to face the left side of the operator. This enables the operator to perceive that the first mounting member 101 is in an incorrect orientation.

The second mounting member 102 is designed to be arranged on the right side of the vehicle 50 and has the identification symbol 15 in the form of an arrow that is displayed on the second surface 12b and faces in a direction opposite to that shown in FIG. 9B. When the second mounting member 102 is oriented with the second surface 12b facing upward, it causes the arrow on the second surface 12b to face the right side of the operator. This enables the operator to perceive that the second mounting member 102 is in an incorrect orientation.

The mounting members 10 may alternatively be arranged on a left or right side surface of the vehicle 50 and each designed to have an arrow facing in a forward direction of the vehicle 50. The correct mounting orientation of the mounting member 10, which is designed to be arranged on the left side surface of the vehicle 50, is achieved by directing the arrow toward the left side of the operator. The correct mounting orientation of the mounting member 10, which is designed to be arranged on the right side surface of the vehicle 50, is achieved by directing the arrow toward the right side of the operator.

The second embodiment achieves the same effects as those of the first embodiment by having the same configuration and operation as those of the first embodiment.

### Third Embodiment

The third embodiment will be described below which differs from the first embodiment in the shape of the identification symbols 15. Other configurations are the same as those of the first embodiment. Therefore, only differences from the first embodiment will be described.

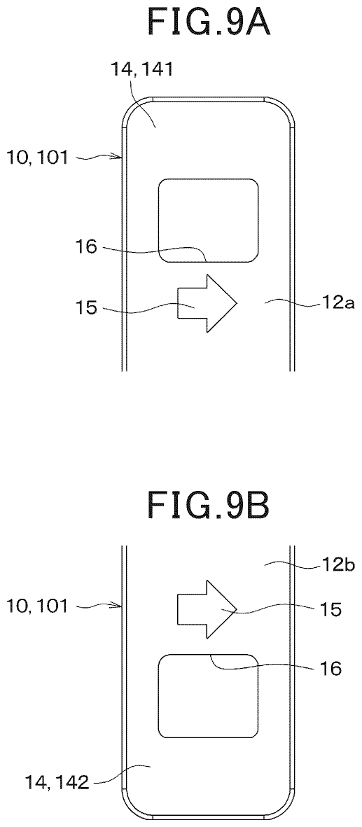

Each of the mounting members 10 in the third embodiment is configured to have the identification symbol 15 which, when the mounting member 10 is in a required mounting orientation, enables the operator to visually perceive the fact. Specifically, as shown in FIG. 10A, the identification symbol 15 displayed on the first surface 12a of each of the first and second mounting members 101 and 102 is a symbol having a circular shape meaning “acceptable.”

Each of the mounting members 10 is also configured to have the identification symbol 15 which, when the mounting member 10 is in an incorrect mounting orientation, enables the operator to visually perceive the fact. Specifically, as shown in FIG. 10B, the identification symbol 15 displayed on the second surface 12a of each of the first and second mounting members 101 and 102 is a symbol having an X shape meaning “not acceptable.”

The above-described configurations of the mounting members 101 and 102, in which a surface that is to be oriented upward when a corresponding one of the mounting members 101 and 102 is in a correct mounting orientation is determined between the first surface 12a and the second surface 12b, minimize a risk that the first and second mounting members 101 and 102 may be mounted in a reversed orientation.

The above discussion refers to a case in which the circular shape indicates “acceptable” and the X shape indicates “not acceptable”, but however, the circular shape may alternatively indicate “not acceptable”, and the X shape may indicate “acceptable”. In this case, the X-shaped identification symbol 15 may be displayed on the first surface 12a, while the circular-shaped identification symbol 15 may be displayed on the second surface 12b.

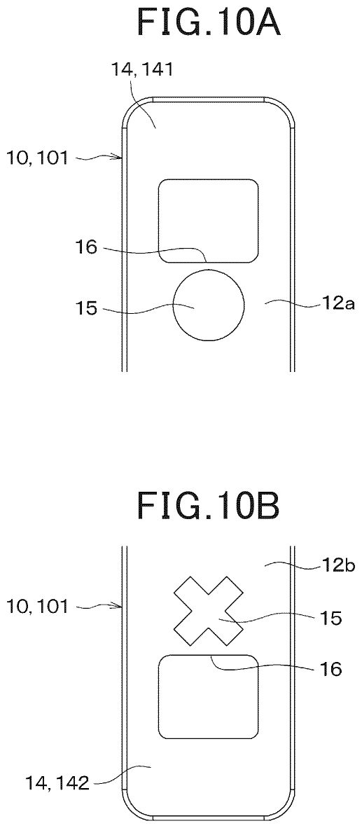

Further, as shown in FIG. 11, an NG symbol, that is, a prohibition symbol, may be displayed on the second surface 12b as the identification symbol 15.

The above-described third embodiment achieves the same effects as those of the first embodiment by having the same configuration and operation as those of the first embodiment.

Further, the third embodiment provides the following effects.

1) When each mounting member 10 is in the required mounting orientation, the identification symbol 15 indicates such fact. This minimizes a risk that each mounting member 10 may be attached to the vehicle 50 in a reversed orientation.

2) When each mounting member 10 is attached to the vehicle 50 in an incorrect mounting orientation, the identification symbol 15 enables the operator to visually perceive the fact, thereby minimizing a risk that each mounting member 10 may be attached to the vehicle 50 in a reversed orientation.

### Fourth Embodiment

The fourth embodiment will be described which differs from the first embodiment in the mounting method of the ultrasonic sensor 20. Other configurations are the same as those of the first embodiment. Therefore, only differences from the first embodiment will be described.

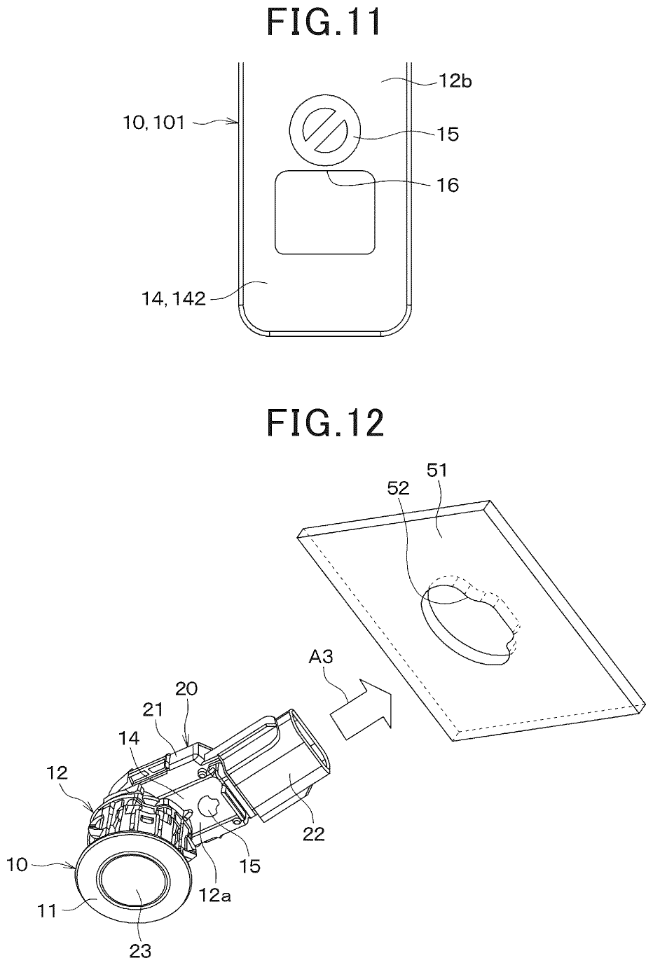

The fourth embodiment is, as illustrated in FIG. 12, designed to install the ultrasonic sensor 20 in the mounting member 10 and then insert the ultrasonic sensor 20, as indicate by the arrow A3, into the mounting hole 52. Each of the plate portions 14 is arranged such that the first surface 12a can be visually confirmed with the ultrasonic sensor 20 fitted in the mounting member 10. The first surface 12a has the identification symbol 15 displayed thereon.

The fourth embodiment achieves the same effects as those of the first embodiment by having the same configuration and operation as those of the first embodiment.

### Other Embodiments

It should be noted that the present disclosure is not limited to the above-described embodiments, and various modifications can be made as appropriate. Further, the respective embodiments described above are not mutually unrelated and may be appropriately combined unless such combinations are clearly impossible. Further, in each of the above-described embodiments, it goes without saying that constituent elements of the embodiment are not necessarily essential unless they are expressly stated to be essential or are considered to be obviously essential in principle. Further, in each of the above-described embodiments, when numerical values such as the number, quantity, or range of constituent elements of the embodiment are mentioned, such numerical values are not limited to the specified values unless they are expressly stated to be essential or are clearly limited to specific values in principle. Further, in each of the above-described embodiments, when shapes, positional relationships, and the like of constituent elements are mentioned, such shapes, positional relationships, and the like are not limited thereto unless they are expressly stated or are clearly limited to specific shapes or positional relationships in principle.

In the second and third embodiments, the identification symbols 15 having shapes corresponding to the shapes of the mounting holes 52 may be displayed on the first surface 12a in the same manner as in the first embodiment. Further, in the third embodiment, the arrow-shaped identification symbols 15 may be displayed on the first surface 12a in the same manner as in the second embodiment.

Aspects in this Disclosure

### First Aspect

A mounting member (10) for attaching a component to a vehicle, wherein the mounting member has displayed thereon an identification symbol (15) indicating a mounting orientation thereby by shape.

### Second Aspect

The mounting member as set forth in the above-described first aspect, wherein the mounting member has a first surface (12a) and a second surface (12b) opposite to the first surface, and the identification symbol includes a first identification symbol displayed on the first surface and a second identification symbol displayed on the second surface. The first identification symbol has a shape symmetric to the second identification symbol.

### Third Aspect

The mounting member as set forth in the above-described first or second aspect, wherein the identification symbol is shaped to correspond to the shape of a mounting hole (52, 521, 522, 523, 524) formed in the vehicle.

### Fourth Aspect

The mounting member as set forth in any one of the above-described first to third aspects, wherein when the mounting member is in a required mounting orientation, the identification symbol is displayed to indicate that the mounting member is in the required mounting orientation.

### Fifth Aspect

The mounting member as set forth in any one of the above-described first to fourth aspects, wherein when the mounting member is in an incorrect mounting orientation different from a required mounting orientation, the identification symbol is displayed to indicate that the mounting member is in the incorrect mounting orientation.

### Sixth Aspect

The mounting member as set forth in any one of the above-described first to fifth aspects, further comprising:
an annular portion (11); and
an upright portion (12) erected from the annular portion.

The upright portion has formed therein an opening (16) for engaging the component. The identification symbol is displayed between the opening and the annular portion.

### Seventh Aspect

The mounting member as set forth in any one of the above-described first to sixth aspects, wherein the component is attached to a bumper (51) having a flat inner surface.

### Eighth Aspect

The mounting member as set forth in any one of the above-described first to seventh aspects, wherein the component is attached to a portion of a bumper (51) of the vehicle, the portion being made of metal.

### Ninth Aspect

The mounting member as set forth in any one of the above-described first to eighth aspects, wherein the component is an ultrasonic sensor (20, 201, 202, 203, 204) configured to detect an object around the vehicle.

What is claimed is:

1. A mounting member for attaching a component to a vehicle,
wherein the mounting member has displayed thereon an identification symbol indicating a mounting orientation thereby by shape.

2. The mounting member as set forth in claim 1, wherein
the mounting member has a first surface and a second surface opposite to the first surface, and
the identification symbol includes a first identification symbol displayed on the first surface and a second identification symbol displayed on the second surface, the first identification symbol having a shape symmetric to the second identification symbol.

3. The mounting member as set forth in claim 1, wherein the identification symbol is shaped to correspond to the shape of a mounting hole formed in the vehicle.

4. The mounting member as set forth in claim 1, wherein when the mounting member is in a required mounting orientation, the identification symbol is displayed to indicate that the mounting member is in the required mounting orientation.

5. The mounting member as set forth in claim 1, wherein when the mounting member is in an incorrect mounting orientation different from a required mounting orientation, the identification symbol is displayed to indicate that the mounting member is in the incorrect mounting orientation.

6. The mounting member as set forth in claim 1, further comprising:
an annular portion; and
an upright portion erected from the annular portion,
wherein the upright portion has formed therein an opening for engaging the component, and
wherein the identification symbol is displayed between the opening and the annular portion.

7. The mounting member as set forth in claim 1, wherein the component is attached to a bumper having a flat inner surface.

8. The mounting member as set forth in claim 1, wherein the component is attached to a portion of a bumper of the vehicle, the portion being made of metal.

9. The mounting member as set forth in claim 1, wherein the component is an ultrasonic sensor configured to detect an object around the vehicle.
